(19) United States
(12) Patent Application Publication
(10) Pub. No.: US 2012/0159488 A1
(43) Pub. Date: Jun. 21, 2012

(54) MANAGING TASKS AND INFORMATION

(75) Inventors: Kerry Ivan Kurian, Phoenix, AZ (US); Roy William Black, Phoenix, AZ (US)

(73) Assignee: Kixia, Inc., Cambridge, MA (US)

(21) Appl. No.: 12/972,538

(22) Filed: Dec. 20, 2010

(51) Int. Cl. G06F 9/46

(52) U.S. Cl. 718/100

(57) ABSTRACT

A system, method, and computer program product are disclosed. These relate to monitoring a plurality of information sources for messages; storing the messages in a database; and transmitting a list of the messages, the list having a first message and including a set of actions associated with the first message, the set of actions including a create-task action and a create-and-delegate-task action.

### TECHNICAL FIELD

This application relates to managing tasks and information.

### BACKGROUND

People are awash in information such as incoming messages, news articles, notes, and so on. Some of this information includes assignments, to-do items, information relating to projects or requiring follow-up, and so on.

### SUMMARY

In one aspect, this application discloses a method that includes monitoring a plurality of information sources for messages; storing the messages in a database; and transmitting a list of the messages, the list having a first message and including a set of actions associated with the first message, the set of actions including a create-task action and a create-and-delegate-task action. The set of actions may further include a create-task-and-mark-it-as-complete action.

In one aspect, this application discloses a system including a computing system configured to monitor a plurality of information sources for messages and to transmit a list of the messages, the list having a first message and including a set of actions associated with the first message, the set of actions including a create-task action and a created-and-delegate-task action. The set of actions may further include a create-task-and-mark-it-as-complete action.

In one aspect, this application discloses a computer program product embodied in a non-transitory computer readable medium, the computer program product including computer code that, when run on a computing system, performs the steps of monitoring a plurality of information sources for messages; storing the messages in a database; and transmitting a list of the messages, the list having a first message and including a set of actions associated with the first message, the set of actions including a create-task action and a create-and-delegate-task action. The set of actions may further include a create-task-and-mark-it-as-complete action.

These general and specific aspects may be implemented using a system, a method, or a computer program, or any combination of systems, methods, and computer programs.

Other aspects, features, and advantages will be apparent from the following detailed description, the drawings, and the claims.

### BRIEF DESCRIPTION OF THE FIGURES

FIG. 1 is a schematic of a task management system in context.

FIG. 2 is a flowchart for generating messages.

FIG. 3 is a schematic of a group of actions.

FIG. 4 is a flowchart for retrieving messages.

FIG. 5 is a flowchart for retrieving messages.

FIG. 6 is a flowchart for retrieving messages.

FIG. 7 is a schematic of a task management system in context.

FIG. 8 is a schematic of a task.

FIG. 9 is a schematic of a delegation.

FIG. 10 is a flowchart for delegating and completing a task.

FIG. 11 is a schematic of a task management system in context.

FIG. 12 is a schematic of an engagement action.

FIG. 13 is a schematic of an engagement response.

FIG. 14 is a flowchart for engaging a nonuser on a task.

FIG. 15 is a flowchart for acceptance of task by a nonuser.

FIG. 16 is a flowchart for converting a nonuser to a user.

FIG. 17 is a schematic of a task management system in context.

FIG. 18 is a flowchart for reassigning a delegation of a task.

FIG. 19 is a schematic of a task management system in context.

FIG. 20 is a flowchart for delegating a delegated task.

FIG. 21 is a flowchart for notifying a party.

FIG. 22 is a schematic of a second group of actions.

FIG. 23 is a schematic of a task management system in context.

FIG. 24 is a flowchart for delegating a task as subtasks.

FIG. 25 is a schematic of a computer.

FIG. 26 is a schematic of a peer-to-peer computing system.

FIG. 27 is a schematic of a client-server computing system.

### DETAILED DESCRIPTION

Among other things, techniques described herein help people get things done through improved management of information and assignments. Incoming messages are collected from myriad sources and presented to users in a way that allows for rapid triage. During triage, user-selected messages are converted into tasks. Tasks are readily assigned, delegated, reassigned, re-delegated, broken into subtasks, and tracked to completion.

To this end, implementations process a variety of digital messages. A “digital message” includes a message in any digital format, including without limitation an email message, an Short Message Service (SMS) message, a Multimedia Message Service (MMS) message, a Really Simple Syndication (RSS) item or feed, an iCalendar (iCal) item or feed, a HyperText Markup Language (HTML) message, an eXtensible Markup Language (XML) message, and so on.

Generating, communicating, transmitting, etc. a digital message can include applying access controls limiting who can receive or decode the digital message and can include delays during which the digital message can be reordered with respect to another digital message, deleted, combined into a single digital message along with another digital message, split into more digital messages, etc.

Digital messages can be concatenated, nested, zipped-up together, or the like, so that a single digital message can include a plurality of digital messages. Thus generating, communicating, transmitting, etc. a single digital message can respectively include generating, communicating, transmitting, etc. of a plurality of digital messages.

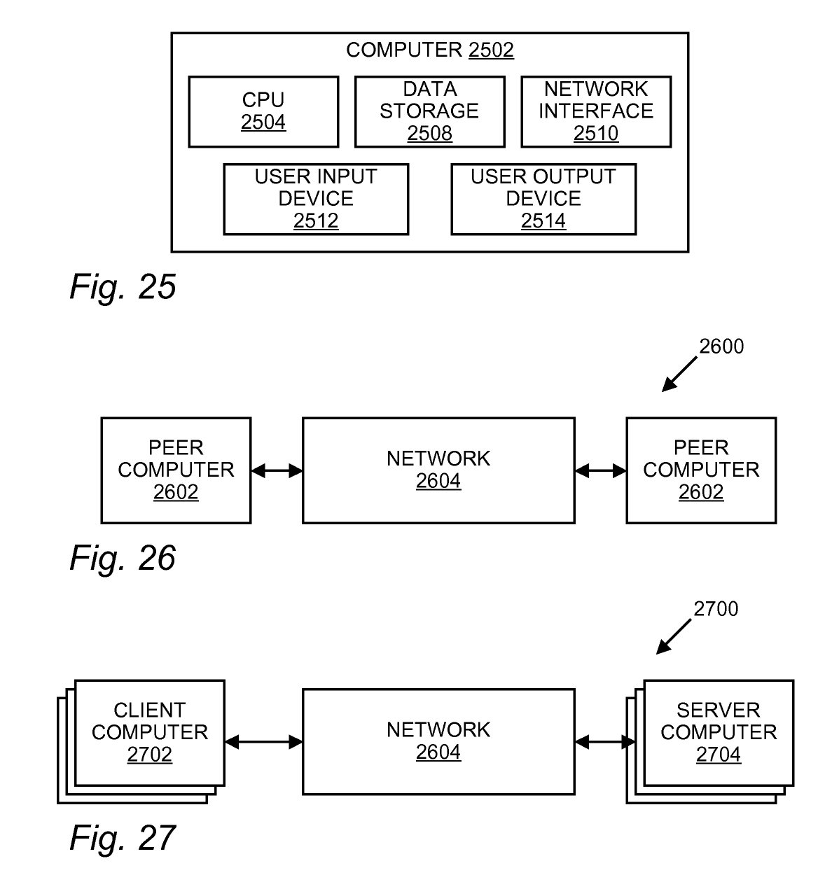

A digital communication network carries the digital message from one computer to another. Examples of such networks and computers are expressly described hereinafter with reference to FIGS. 25-27 and others will be appreciated.

Throughout this application references to “software” can include computer program code stored in non-transitory computer readable medium. Furthermore, throughout this application implementations described as “in a computer” (e.g., “the widget can be implemented in a computer”) include hardware implementations, software implementations, combinations of hardware and software implementations, and so on. Unless otherwise expressed or clear from the context, these hardware implementations include a general-purpose computer, an application-specific computer, a personal computer, a server computer, a smart phone, a set-top box, a game console, and so on.

Unless otherwise clear from the context, “generating” a thing can include creating and transmitting that thing. For example, “generating a notification” can include creating and transmitting the notification.

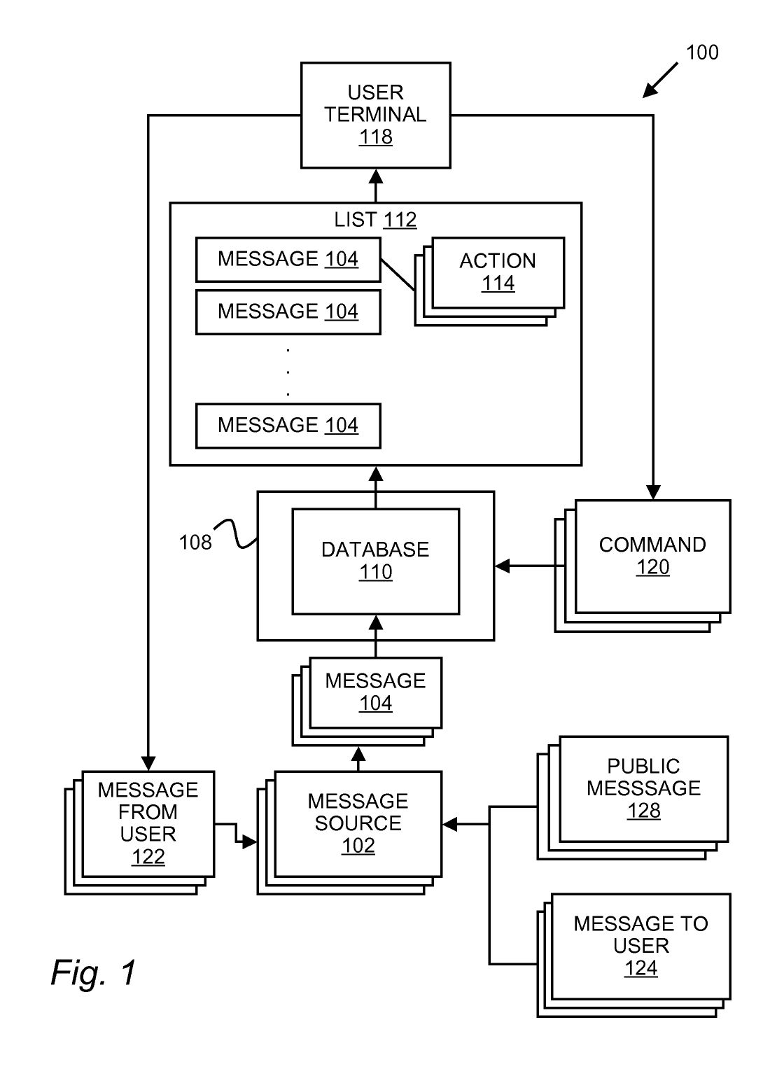

Referring to FIG. 1, a task management context 100 includes a task management system 108 including a database 110. The task management system 108 enables a user to triage a plurality of messages by presenting user-selectable actions in association with messages in a list. Upon selection, the actions cause a message to be removed from the list and placed into a trash bin, a to-do list, an archive, etc. as appropriate. In this way, a user can quickly sort through incoming information, if only to proactively defer some of it or delegate some of it out to others.

The task management system receives a plurality of messages (individually, message 104) from a plurality of message sources (individually, message source 102) and transmits a list 112 to a user terminal 118. The list 112 includes at least some of the plurality of messages along with a plurality of actions (individually, action 114) associated with the first message 104 in the list 112. The user terminal 118 receives the list 112 and presents it to a user. The user selects at least one of the plurality of actions, which causes the user terminal 118 to send at least one of a plurality of commands (individually, command 120) back to the task management system 108, which in turn updates the list 112 to remove the first message 104 and reveal a new first message 104.

The plurality of messages includes a plurality of messages-from-user (individually, message-from-user 122) and a plurality of messages-to-user (individually, message-to-user 124). A message source 102 receives each message-from-user 122 and each message-to-user 124 and transmits them to the task management system 108. In addition, the task management system 108 may itself generate some of the plurality of messages.

The message source 102 provides the message 104 to the task management system 108. Implementations of the message source 102 can include a computer such as an email server, an instant messaging server, an SMS server, an MMS server, an RSS server, an iCal server, a social media messaging server (such as those of FACEBOOK, TWITTER, LINKEDIN, etc.), or the like. The message source 102 can be implemented in a computer, including without limitation a remote server.

The message 104 is a digital message and can include a message-from-user 122, a message-to-user 124, a public message 128, etc. The message-from-user 122 is a digital message that is created by the user. The message-to-user 124 is a digital message that is expressly addressed to the user, but not created by the user. The public message 128 is a digital message available to the user, but not expressly addressed to the user and not created by the user.

The task management system 108 receives the message 104 from the message source 102 via the digital communication network. The task management system 108 stores the message 104 in the database 110. The task management system 108 transmits the list 112 to the user terminal 118. The task management system 108 receives the command 120 and processes it as described herein. Unless otherwise stated or clear from the context, the task management system 108 carries out the steps in the flowcharts described herein. The task management system 108 can automatically carry out any and all of these steps, such as in response to a default or preference; in response to a program's output; and so on. When the task management system 108 carries out a step (whether automatically or in response to a command), it may transmit a notification, digital message, etc. to notify affected parties (e.g., assigned party, delegating party, delegated party, and so on). The task management system 108 can be implemented in a computer.

The task management system can create, receive, or retrieve an altered version of the message 104 from the message source 102 and can insert the altered version into the list 112 along with or instead of the message 104. The altered version of the message 104 can include a translation, graphical representation, summary, abridged version, reformatted version, etc. of the message 104.

The user terminal 118 receives the list 112 from the task management system 108 and may display the list 112; receive human input indicating a selection of one of the actions in the list 112; and then transmit, responsive to the human input, at least one of the plurality of commands to the task management system 108. In some implementations, the user terminal 118 may transmit at least one of the plurality of commands automatically, such as in response to a default or preference (e.g., for all messages addressed to user X from source Y send command Z); in response to an algorithm's output (e.g., for all messages marked as spam by an automatic spam filter, send command A); and so on. In some implementations, the user terminal 118 may transmit at least one of the plurality of commands in response to a direct-entry by a user (e.g., the user enters the command at a command prompt without selection of one of the actions in the list 112). The user terminal 118 can be implemented in a computer.

Some implementations of the user terminal 118 include a computer with a human-computer terminal-type interface, including a graphical display, a mouse, a keyboard, and so on. Other implementations of the user terminal 118 include a computer without a human-computer terminal-type interface, such as and without limitation a server computer in a datacenter, a game console with a graphical display and a gesture-recognition input device, a smart phone, a tablet computer, and so on. Implementations of the user terminal 118 can include a robot or other automatic system that emulates some or all of the user/nonuser/party actions described in this application (e.g., user/nonuser/party selection of something, user/nonuser/party interaction with something, user/nonuser/party attempt to do something, etc.). Implementations of the user terminal 118 can include a client application such as a web browser, a dedicated software application, or the like. Other implementations of the user terminal 118 will be appreciated.

The action 114 in the list 112 is something (e.g., a link, a button, a widget, an app, or the like) that, upon selection by a user, causes the user terminal 118 to transmit at least one command 120. The action 114, any number of which can appear in the list 112, may be selected from a group of actions 300 described in detail hereinafter with reference to FIG. 3.

The command 120 is a digital message from the user terminal 118 to the task management system 108 pertaining to a message 104 in the list 112. Implementations of the command 120 can include a reference to or identifier of the pertinent message 104 so that the task management system 108 can apply the command 120 to that message 104.

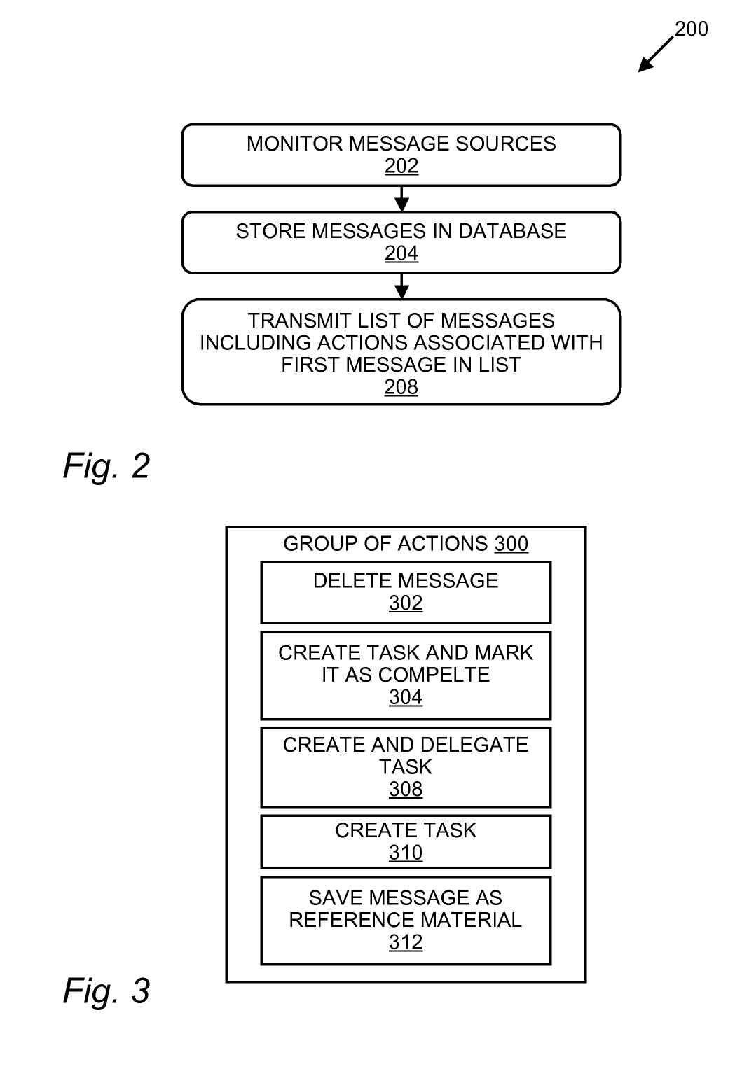

Referring to FIG. 2, the plurality of message sources is monitored for incoming messages (step 202). These messages are retrieved/received and stored in the database 110 (step 204). The list 112 is transmitted (step 208). The steps 202-208 can be carried out simultaneously, with the list 112 being transmitted substantially in real time and in response to the message 104 being stored in the database 110. Thus, the list 112 may be dynamically updated to reflect the incoming messages substantially as they arrive.

Referring to FIG. 3, the group of actions 300 includes a delete-message action 302, a create-task-and-mark-it-as-complete action 304, a create-and-delegate-task action 308, a create-task action 310, and a save-message-as-reference-material action 312. The delete-message action 302 is an action 114 that upon selection by a user causes the user terminal 118 to transmit at least one command 120 indicating that the user wishes to delete the message 104 associated with the plurality of actions. The create-task-and-mark-it-as-complete action 304 is an action 114 that upon selection by a user causes the user terminal 118 to transmit at least one command 120 indicating that the user wishes to create a task from the message 104 associated with the plurality of actions and then mark said task as complete. The create-and-delegate-task action 308 is an action 114 that upon selection by a user causes the user terminal 118 to transmit at least one command 120 indicating that the user wishes to create a task from the message 104 associated with the plurality of actions and then delegate said task. The create-task action 310 is an action 114 that upon selection by a user causes the user terminal 118 to transmit at least one command 120 indicating that the user wishes to create a task from the message 104 associated with the plurality of actions. The save-message-as-reference-material action 312 is an action 114 that upon selection by a user causes the user terminal 118 to transmit at least one command 120 indicating that the user wishes to store as reference material the message 104 associated with the plurality of actions. Other examples and implementations of an action 114 are described below and still others will be appreciated.

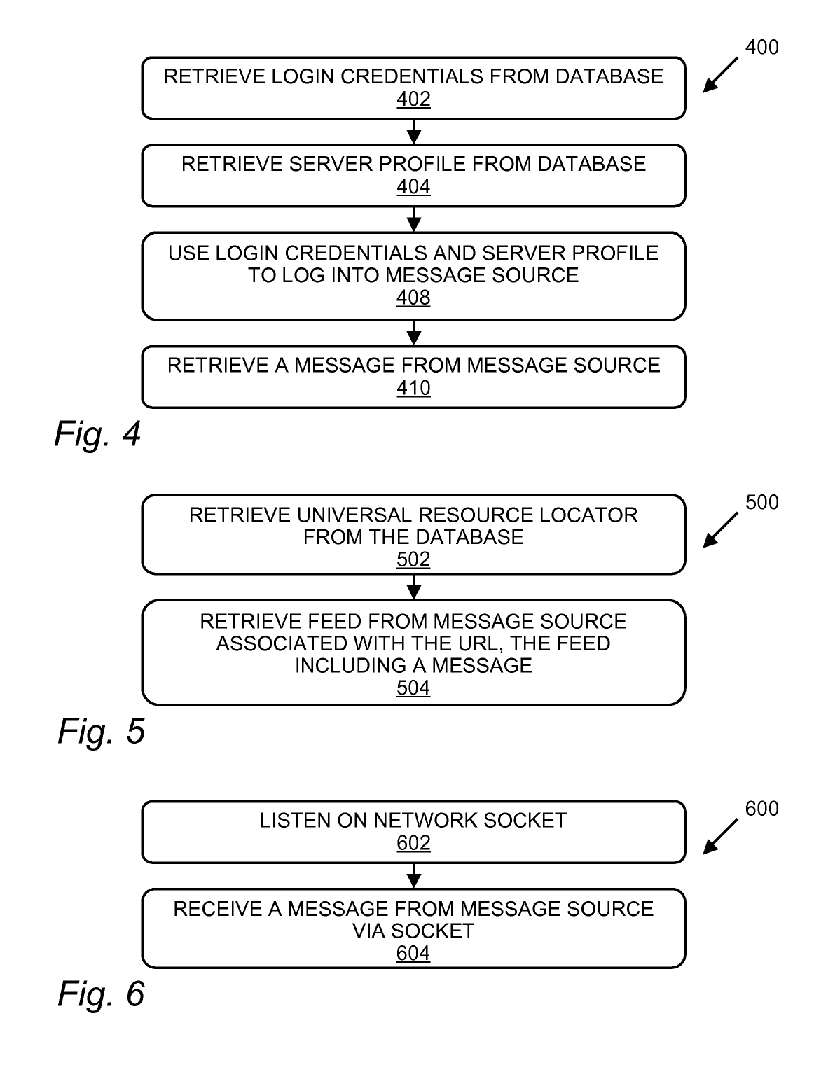

The task management system 108 can employ a number of methods to retrieve or receive the plurality of messages from the message sources. Without limitation, three such methods are described below with reference to FIGS. 4-6. Other methods will be appreciated.

Referring to the flowchart 400 of FIG. 4, login credentials are retrieved from the database 110 (step 402). A server profile is retrieved from the database 110 (step 404). Both the login credentials and the server profile correspond to a message source 102 and together provide enough information for the task management system 108 to locate and connect to the message source 102 on behalf of a user. For example and without limitation, the login credentials may include a user name and password while the sever profile may include an IP address, a TCP/IP port number, and a protocol identifier (e.g., POP, HTTP, FTP, etc.). Using the login credentials and the server profile, a user-login session is established with the message source 102 (step 408). Via this session, a message 104 is retrieved from the message source 102 (step 410).

Referring to the flowchart 500 of FIG. 5, a Universal Resource Locator (URL) is retrieved from the database 110 (step 502). A feed is retrieved from a message source 102 associated with the URL (step 504). The feed includes the message 104.

Referring to the flowchart 600 of FIG. 6, a network socket is created in a listening state (step 602). The message 104 is received via the socket (step 604). The socket may be a datagram socket, a stream socket, a raw socket, or the like.

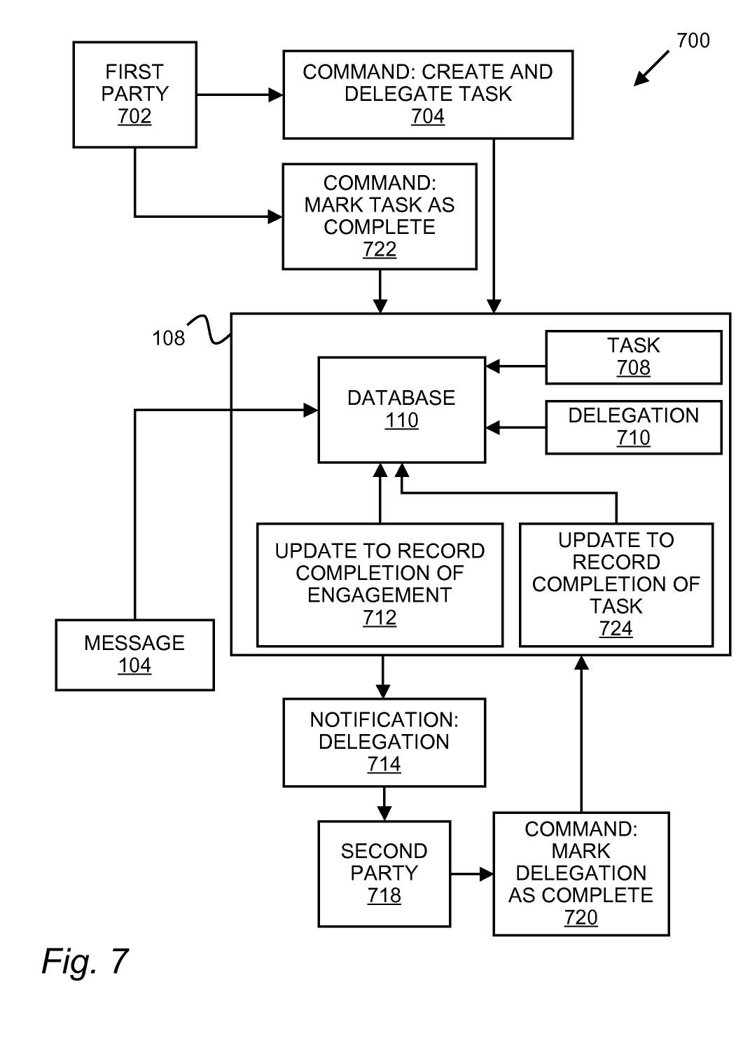

Referring to FIG. 7, the task management system 108 enables a first party 702 to receive a message 104, convert the message 104 into a task 708, and create a delegation 710 of the task 708 to a second party 718. Typically, the second party 718 will command the task management system 108 to mark the delegation 710 as complete and then the first party 702 will command the task management system 108 to mark the task 708 as complete. In this way, the first party 702 can rapidly dispatch with the message 104 via the delegation 710 of the task 708 to the second party 718, while maintaining final authority over whether the task 708 has been completed.

For example, Alice delegates a task to Bob. (The task 708 and the delegation 710 are written to the database 110.) Bob works on the task and then marks it as complete. (The delegation-complete update 712 is written to the database 110 to record that the delegation 710 is complete, but the task 708 itself has not been marked as complete because Alice may want an opportunity to review Bob's work.) Alice reviews Bob's work and marks the task as complete. (The task-complete update 724 is written to the database 110, marking the task 708 as complete.)

A task management context 700 includes the message 104, the task management system 108, the database 110, the first party 702, the second party 718, the task 708, and the delegation 710. The task management context 700 also includes a create-and-delegate-task command 704, a delegation-complete update 712 that reflects completion of a task, a delegation notification 714, a mark-delegation-as-complete command 720, and a mark-task-as-complete command 722.

The first party 702 and the second party 718 each interact with the task management system 108 via respective instances of the user terminal 118. The first party 702 and the second party 718 can each include an individual, a group of individuals, an organization, an automatic system or robot, or the like.

The first party 702 sends the create-and-delegate-task command 704 to the task management system 108. The task management system 108 receives the create-and-delegate-task command 704 and then creates the task 708, creates the delegation 710, and writes the task 708 and the delegation 710 to the database 110. The task management system 108 sends the delegation notification 714 to the second party 718. The second party 718 receives the notification of delegation 714 from the task management system 108 and sends the mark-delegation-as-complete command 720 to the task management system 108. The task management system 108 receives the mark-delegation-as-complete command 720 and writes the delegation-complete update 712 to the database 110 so as to reflect completion of the delegation 710. The first party 702 sends the mark-task-as-complete command 722 to the task management system 108. The task management system 108 receives the mark-task-as-complete command 722 and writes the task-complete update 724 to the database 110 to reflect completion of the task 708.

The create-and-delegate-task command 704 is a command 120 that causes the task management system 108 to create both the task 708 and the delegation 710. In this way, a message 104 can be converted into a task 708 while also delegating responsibility for completion of the task 708 from the first party 702 to the second party 718.

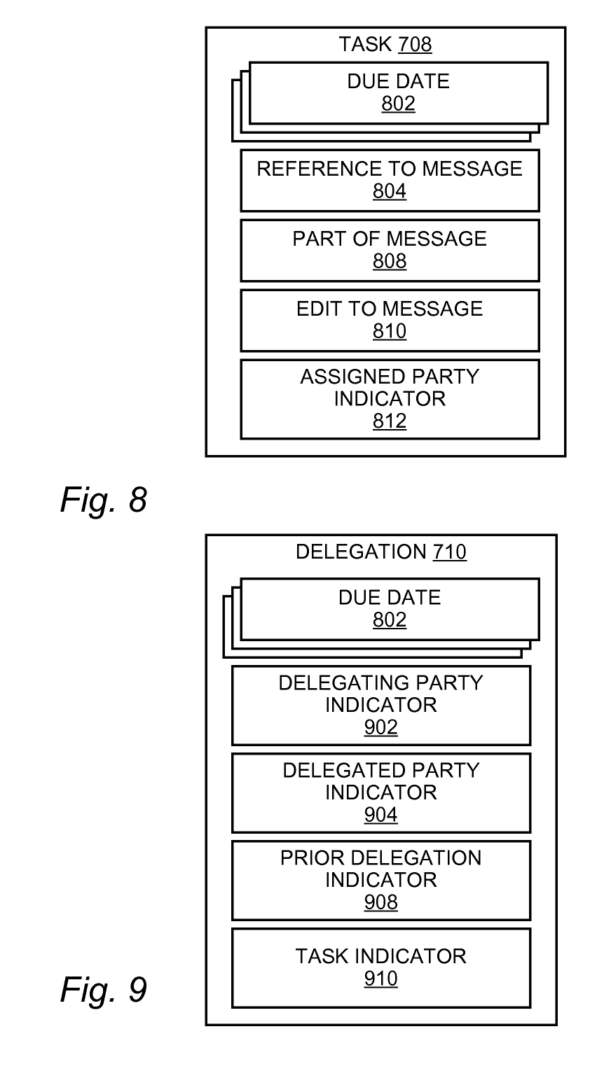

The task 708 is described in detail hereinafter with reference to FIG. 8.

The delegation 710 indicates a party to whom the task 708 is delegated (“delegated party”), such as and without limitation the second party 718. For example, in the context of FIG. 7, the party to whom the task 708 is delegated is the second party 718. The task management system 108 creates the delegation 710 in response to a command 120, such as and without limitation the create-and-delegate-task command 704. The delegation 710 is stored in the database 110. The delegation 710 is described in greater detail hereinafter with reference to FIG. 9.

The delegation-complete update 712 indicates completion of the delegation 710, and is written to the database 110 in response to a command 120, such as and without limitation the mark-delegation-as-complete command 720.

The delegation notification 714 is a digital message transmitted by the task management system 108 to the delegated party, notifying the delegated party of the delegation 710. The delegation notification 714 can include a description of the task 708, a description of the delegation 710, an action 114 for marking the task as complete, a link to a web page describing the task 708, the delegation 710, or the like.

The mark-delegation-as-complete command 720 is a command 120 that causes the task management system 108 to write the delegation-complete update 712 to the database 110, thus recording that the delegation 710 is complete and returning responsibility for completion of the task 708 to the party that initiated the delegation 710 (“delegating party”). In this way, the second party 718 can complete work on the task 708 and then return responsibility for task 708 back to the first party 702 for final approval or the like.

The task-complete update 724 indicates completion of the task 708, and is written to the database 110 in response to a command 120, such as and without limitation the mark-task-as-complete command 722.

The mark-task-as-complete command 722 is a command 120 that causes the task management system 108 to write the task-complete update 724 to the database 110. In this way, the first party 702 can mark the task 708 as complete after the second party 718 completes work on the task and, perhaps, after the first party 702 completes work on the task, too.

In some implementations the mark-task-as-complete command 722 is implied by a preference of the first party 702 rather than being expressed by the first party 702. For example, the first party 702 may specify a preference like, “I don't need to review Bob's work on this task. When he marks the delegation as complete, please automatically mark the task as complete, too.” In such cases the first party 702 does not send the mark-task-as-complete command 722. Instead, the task management system 108 marks the task 708 as complete in response to the mark-delegation-as-complete command 720. A variety of ways of eliciting, receiving, recalling, etc. the preference of the first party 702 will be appreciated.

Referring to FIG. 8, the task 708 includes a plurality of due dates (individually, due date 802), a message reference 804, a message part 808, a message edit 810, and an assigned-party-indicator 812.

The due date 802 includes a date on which the task 708 is due. The due date 802 can include a calendar date, a time, an indication of “as soon as possible,” an indication of “someday/maybe,” and so on. The task 708 can include numerous due dates 802, such as one for a final due date, one for an internal or intermediate due date, and so on.

The message reference 804 is something that enables the task management system 108 to recall the message 104 from which the task 708 was created. Implementations of the message reference 804 can include an index into a table of messages in the database 110, a hash of the message 104, or any other unique identifier of the message 104.

The message part 808 includes at least a part of the message 104 from which the task 708 was created. This allows the task management system, when recalling the task 708, to recall the messages part 808 without retrieving/decoding/processing/etc. the entire message 104.

The message edit 810 includes an edit to the message 104 from which the task was created. For example, the message edit 810 can include a redaction of the message 104, comments, and so on.

The assigned-party indicator 812 indicates which party is ultimately responsible for completion the task 708—that is, the party to whom the task 708 is assigned.

Referring to FIG. 9, the delegation 710 includes a plurality of due dates (individually, due date 802), a delegating-party indicator 902, a delegated-party indicator 904, a prior-delegation indicator 908, and a task indicator 910.

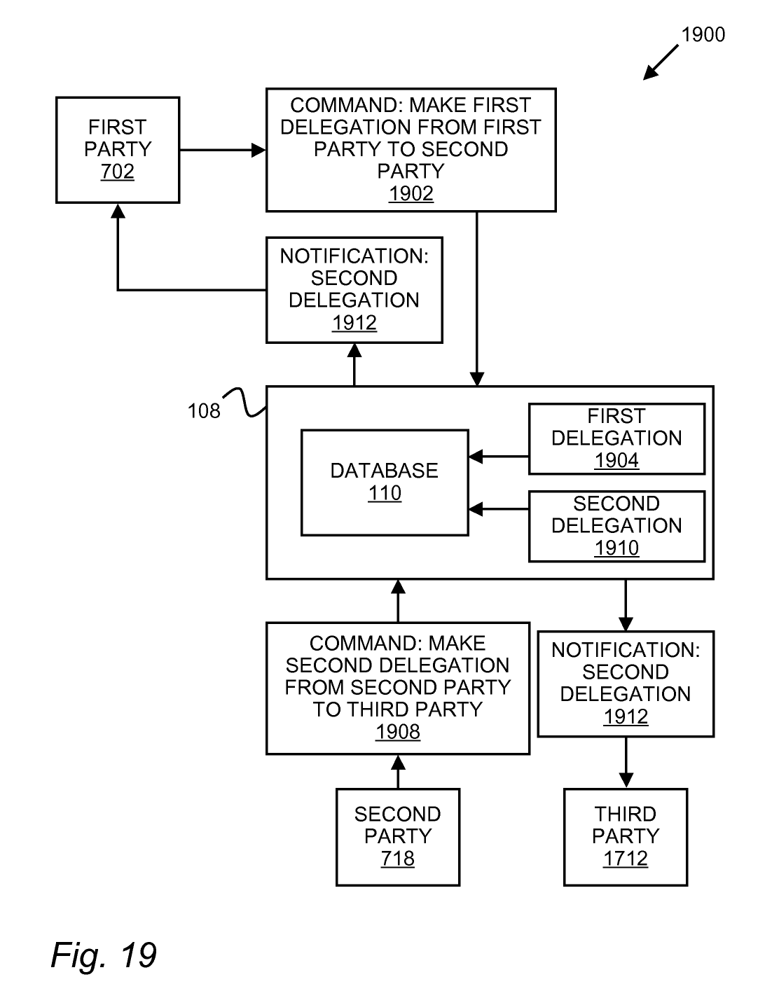

Implementations can include more than one delegation 710 related to a single task 708. This can indicate a tree of delegations. For example, if Alice delegates a task to Bob and Bob then delegates the task Carol, there exists a tree of delegations including one from Alice to Bob and one from Bob to Carol. For another example, if Alice delegates a part of a task to Bob, a part of the task to Carol, and a part of the task to Dave, there exists a tree of delegations: one from Alice to Bob, one from Alice to Carol, and one from Alice to Dave. Trees of delegations are described in greater detail hereinafter with reference to FIG. 19. A variety of trees of delegations will be appreciated.

The delegating-party indicator 902 indicates the party ultimately responsible for completion of the delegation 710. Typically this party is also the one that caused the delegation to be created (e.g., the delegating party). For example, if Alice delegates a task to Bob then Alice is the delegating party (unless she also assigns ultimate responsibility for completion of the delegation 710 to another party).

The delegated-party indicator 904 indicates the party to whom work on the task 708 is delegated. The relationship between the assigned-party of the task and the delegated-parties of the task is such that the assigned-party can have final approval authority over work completed by the delegated-parties. Thus, once all delegated-parties mark the delegation 710 as complete, the assigned-party can have a final say as to whether the task is in fact complete or, for example, whether the task needs to be reworked, re-delegated to another party, and so on.

The prior-delegation indicator 908 indicates which delegation 710 immediately precedes the current delegation 710 in the tree of delegations. For example, in the Alice to Bob to Carole example above, one delegation includes {id: delegation-1; delegating-party indicator: Alice; delegated-party indicator: Bob; prior-delegation indicator: <none>) and the other delegation includes {id: delegation-2; delegating-party indicator: Bob; delegated-party indicator: Carol; prior-delegation indicator: delegation-1}.

The task indicator 910 indicates the task 708 to which the delegation 710 pertains.

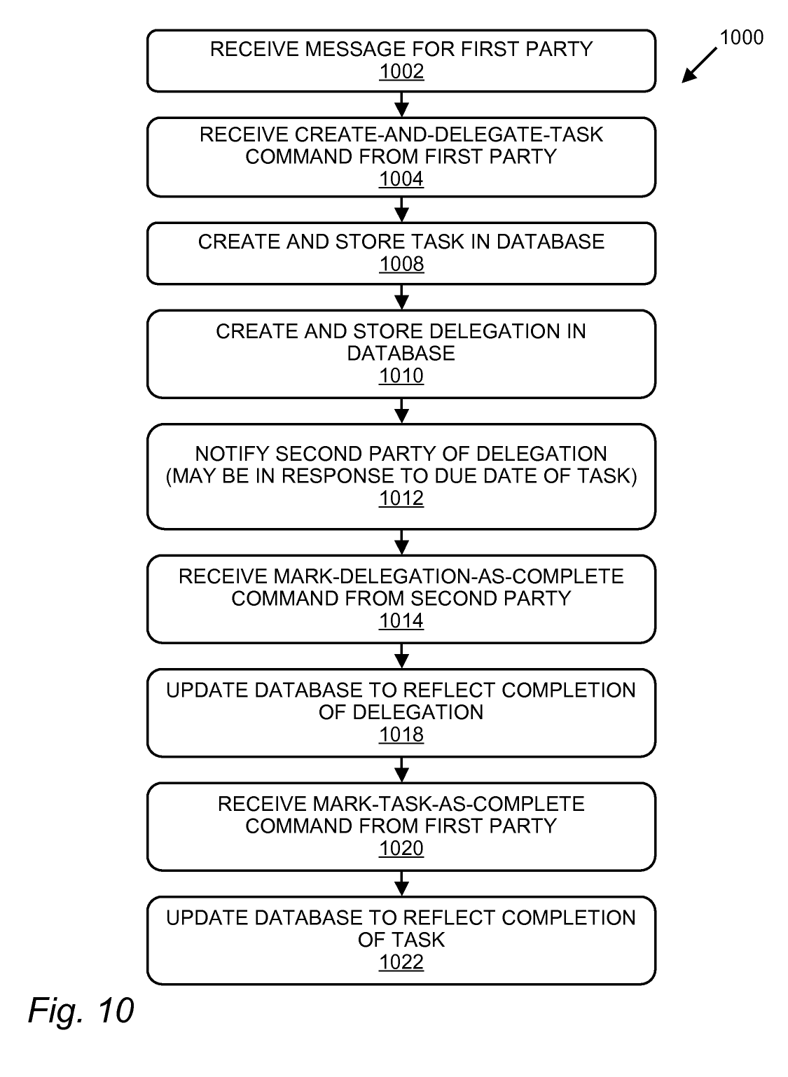

Referring to the flowchart 1000 of FIG. 10, a message 104 is received for the first party 702 (step 1002). The create-and-delegate-task command is received from the first party 702 (step 1004). The task 708 is created and stored in the database 110 (step 1008). The delegation 710 is created and stored in the database 110 (step 1010). The delegation notification 714 is transmitted to the second party 718, perhaps in response to creation/storage of the delegation 710, perhaps in response to the due date 802 of the task 708, or the like (step 1012). The mark-delegation-as-complete command 720 is received from the second party 718 (step 1014). The delegation-complete update 712 is written to the database 110 (step 1018). The mark-task-as-complete command 722 is received from the first party 702 (step 1020). The task-complete update 724 is written to the database 110 (step 1022).

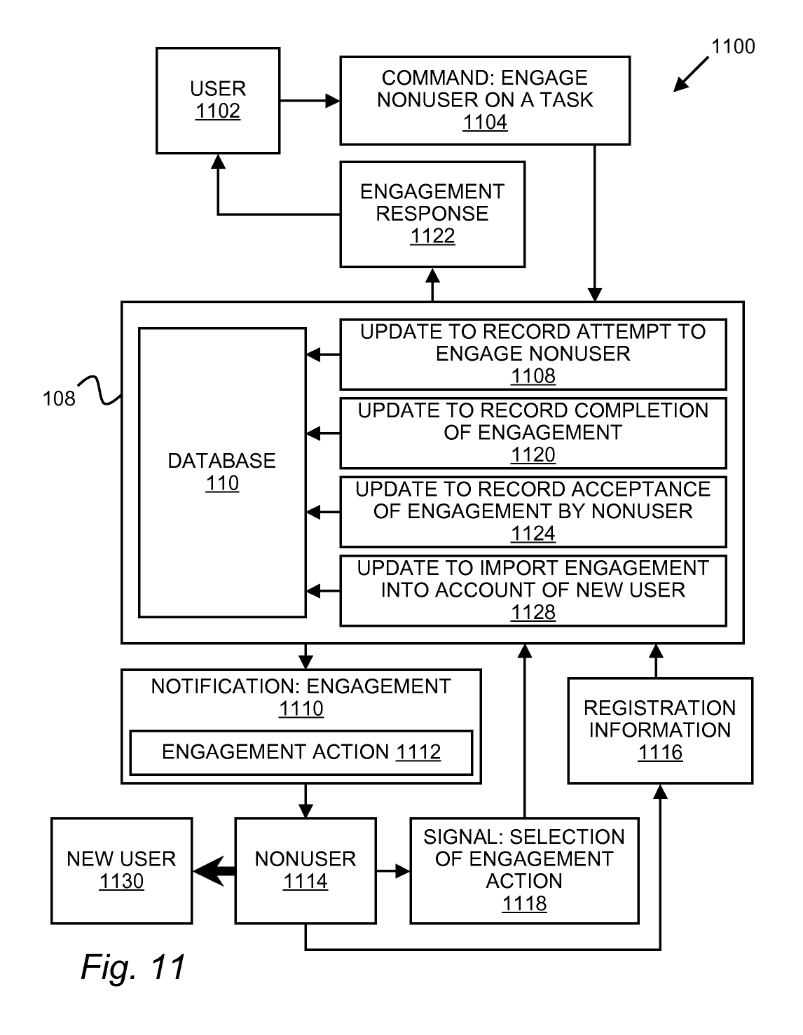

Referring to FIG. 11, the task management system 108 enables a user 1102 (who has an account with the task management system 108) to engage a nonuser 1114 (who does not have an account with the task management system 108) on a task 708. Engaging a nonuser on a task can include delegating a task to the nonuser, assigning a task to the nonuser, etc. as described in this application and as will be appreciated.

A task management context 1100 includes the database 110, the task management system 108, the user 1102, and the nonuser 1114. The task management context 1100 also includes an engage-nonuser-on-task command 1104, an record-attempt-to-engage-nonuser-on-task update 1108, a engagement notification 1110 including an engagement action 1112, registration information 1116, a selection-of-engagement-action signal 1118, a record-completion-of-engagement update 1120, a engagement response 1122, a record-acceptance-of-engagement-by-nonuser-on-a-task update 1124, and an import-engagement-into-account-of-new-user update 1128.

The user 1102 interacts with the task management system 108 via an instance of the user terminal 118. The user 1102 can include an individual, a group of individuals, an organization, an automatic system or robot, or the like. The user 1102 has an account or the like with task management system 108. Access to the account is controlled, such as by way of a user name, password, or any other credentials that are recognized by the task management system 108 and that uniquely identify the user 1102 to the task management system 108. The user 1102 sends the engage-nonuser-on-task command 1104 to the task management system 108 and receives the engagement response 1122 from the task management system 108. In this way the user 1102 can attempt to engage the nonuser 1114 (described below) on a task 708 and, by way of the engagement response 1122 (described below), can learn whether the nonuser 1114 has been engaged on the task 708.

The engage-nonuser-on-task command 1104 is a command 120 that instructs the task management system 108 to attempt to engage the nonuser 1114 on a task 708.

The record-attempt-to-engage-nonuser-on-a-task update 1108 indicates that the user 1102 has attempted to engage the nonuser 1114 on a task 708, and is written to the database 110 in response to the engage-nonuser-on-task command 1104.

The engagement notification 1110 is a digital message to the nonuser 1114, informing the nonuser 1114 that the user 1102 wishes to engage the nonuser 1114 on a task 708 and providing the nonuser 1114 with an engagement action 1112.

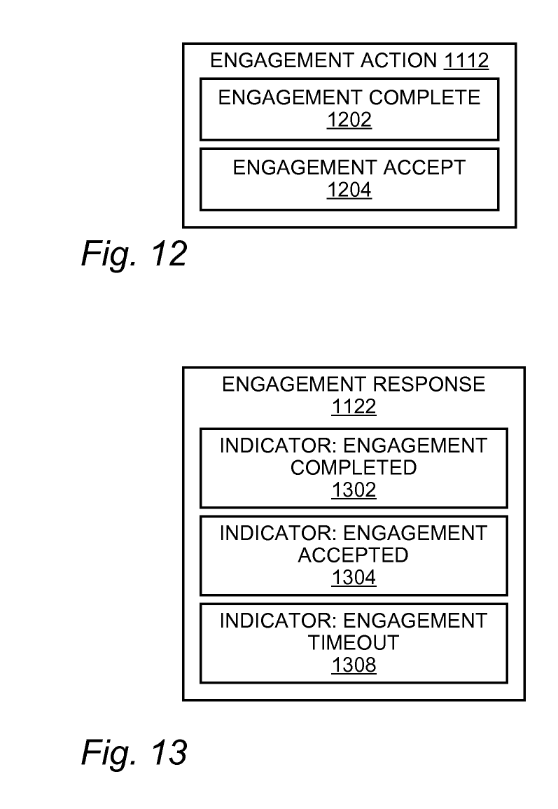

Referring to FIG. 12, the engagement action 1112 includes an engagement-complete action 1202 and an engagement-accept action 1204, both of which are actions 114. The engagement-complete action 1202 is selected by the nonuser 1114 to indicate completion of an engagement on a task 708. For example, the nonuser 1114 could receive a engagement notification 1110 indicating that the user 1102 wishes the nonuser 1114 to engage on a task 708 that includes reading an article. After reading the article, the nonuser 1114 could select the engagement-complete action 1202 to indicate completion of engagement on the task 708. The engagement-accept action 1204 is selected by the nonuser 1114 to indicate acceptance (but not yet completion) of the engagement on the task 708. Continuing with the example, instead of reading the article immediately the nonuser 1114 could select the engagement-accept action 1204 to indicate that he/she/it accepts the task 708 of reading the article and will read the article in the future.

Referring again to FIG. 11, the nonuser 1114 interacts with the task management system 108 via an instance of the user terminal 118. The nonuser 1114 can include an individual, a group of individuals, an organization, an automatic system or robot, or the like. Unlike the user 1102, the nonuser 1114 does not have an account or the like with task management system 108. The nonuser 1114 receives the engagement notification 1110 from the task management system 108 and sends both the selection-of-engagement-action signal 1118 and, optionally, the registration information 1116 to the task management system 108. In this way, the nonuser 1114—without an account at the task management system 108—can learn that the user 1102 wishes to engage him/her/it on a task 708, can indicate that the engagement is accepted and complete (e.g., by selecting the engagement-complete action 1202), can accept the engagement without creating an account (e.g., by selecting the engagement-accept action 1204 but not sending the registration information 1116), can accept the engagement and create an account (as described below, by selecting the engagement-accept action 1204 and sending the registration information 1116), and so on.

The registration information 1116 enables the task management system 108 to create an account uniquely associated with the nonuser 1114. The registration information 1116 can include a user name, a password, an email address, or any other credentials for uniquely identifying or authenticating the nonuser 1114.

The selection-of-engagement-action signal 1118 is a digital message that indicates which engagement action 1112 was selected by the nonuser 1114.

The record-completion-of-engagement update 1120 indicates that the nonuser 1114 has accepted and completed a task 708, and is written to the database 110 in response to the selection-of-engagement-action signal 1118 indicating that the engagement-complete action 1202 was selected.

The record-acceptance-of-engagement-by-nonuser-on-a-task update 1124 indicates that the nonuser 1114 has accepted but not yet completed a task 708, and is written to the database 110 in response to the selection-of-engagement-action signal 1118 indicating that the engagement-accept action 1204 was selected.

If the task management system 108 does not receive the selection-of-engagement-action signal 1118 before the expiration of a time interval, the attempt by the user 1102 to engage the nonuser 1114 on a task can timeout. In this case, the task management system 108 can update the database 110 as appropriate to reflect the timeout, invalidating the engagement notification 1110 and the engagement action 1112.

Referring to FIG. 13, the engagement response 1122 is a digital message selectively including an engagement-completed indicator 1302, an engagement-accepted indicator 1304, and an engagement-timeout indicator 1308. The engagement-completed indicator 1302 serves to notify the user 1102 that the nonuser 1114 accepted/completed the engagement (e.g., as known to the task management system 108 by way of the selection-of-engagement-action signal 1118 indicating that the nonuser 1114 selected the engagement-complete action 1202). The engagement-accepted indicator 1304 serves to notify the user 1102 that the nonuser 1114 accepted but did not yet complete the engagement (e.g., as known to the task management system 108 by way of the selection-of-engagement-action signal 1118 indicating that the nonuser 1114 selected the engagement-accept action 1204). The engagement-timeout indicator 1308 serves to notify the user 1102 that the attempt by the user 1102 to engage the nonuser 1114 has timed-out (e.g., as described above).

The import-engagement-into-account-of-new-user update 1128 is written to the database 110 after a new account has been created for the nonuser 1114 in response to receipt of the registration information 1116. In this way, a nonuser 1114 (without an account) can be converted into a new user 1130 (with a new account) and the task management system 108 can track the new user's acceptance of engagement on a task 708.

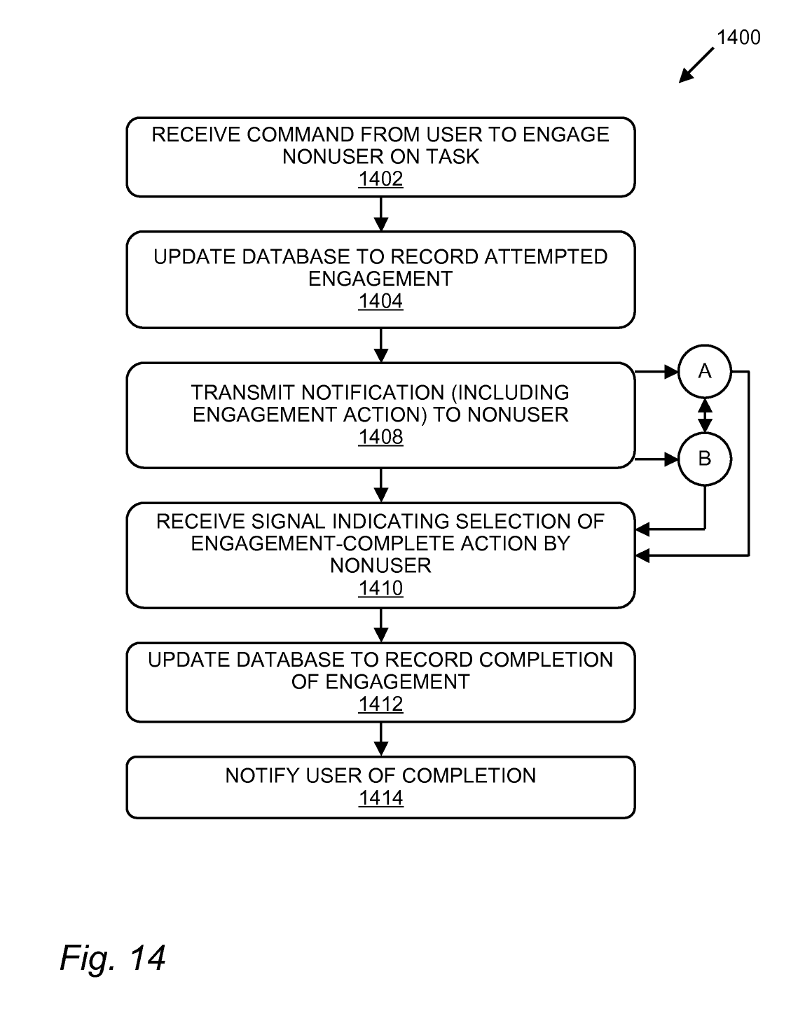

Referring to the flowchart 1400 of FIG. 14, the engage-nonuser-on-task command 1104 is received (step 1402). The record-attempt-to-engage-nonuser-on-task update 1108 is written to the database 110 (step 1404). The notification of engagement 1110 including the engagement action 1112 is transmitted to the nonuser 1114 (step 1408). The selection-of-engagement-action signal 1118 indicating selection of the engagement-complete 1202 action is received (step 1410). The record-completion-of-engagement update 1120 is written to the database 110 (step 1412). The engagement response 1122 is transmitted to the user 1102 (step 1414).

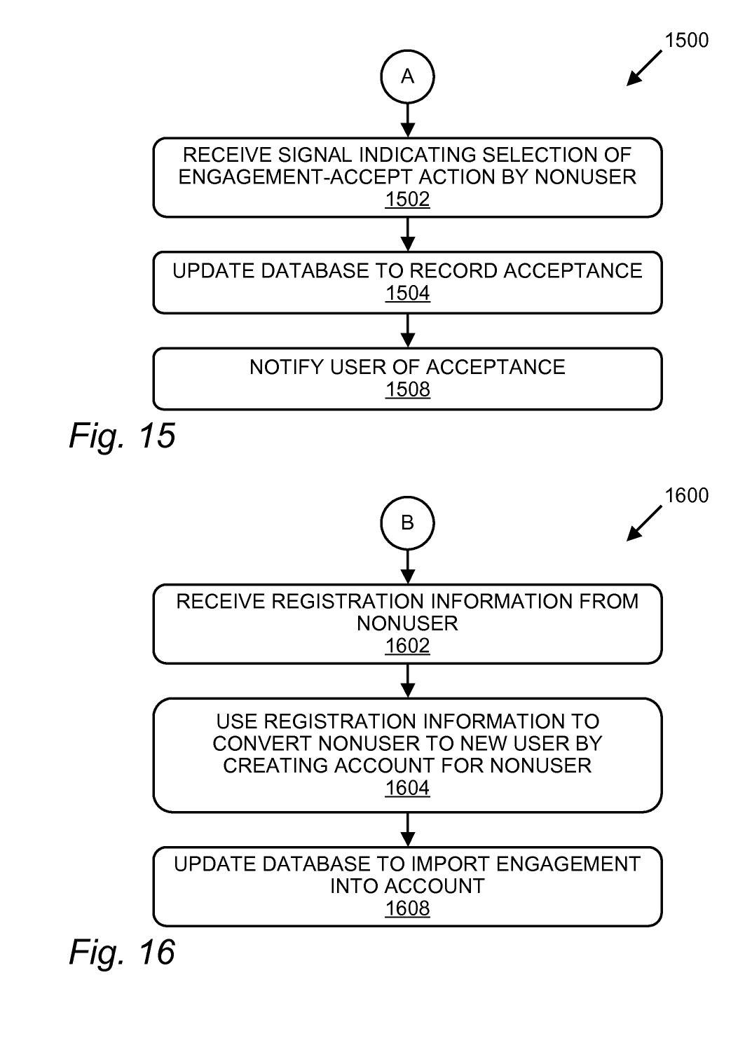

The flowchart 1400 also includes steps A and B, which are described in further detail hereinafter with respective reference to FIGS. 14 and 15. As depicted step A can follow step 1408 or step B, step B can follow step 1408 or step A, and in any case step 1410 can follow steps A or B instead of directly following step 1408.

Referring to the flowchart 1500 of FIG. 15, the selection-of-engagement-action signal 1118 indicating selection of the engagement-accept action 1204 is received (step 1502). The record-acceptance-of-engagement-by-nonuser-on-a-task update 1124 is written to the database 110 (step 1504). The engagement response 1122 including the engagement-accepted indicator 1304 is transmitted to the user 1102 (step 1508).

Referring to the flowchart 1600 of FIG. 16, the registration information 1116 is received from the nonuser 1114 (step 1602). An account including the registration information 1116 is created for or associated with the nonuser 1114, thus converting the nonuser 1114 (who does not have an account at the task management system 108) to a new user (who has an account at the task management system 108) (step 1604). The import-engagement-into-account-of-new-user update 1128 is written to the database 110 (step 1608).

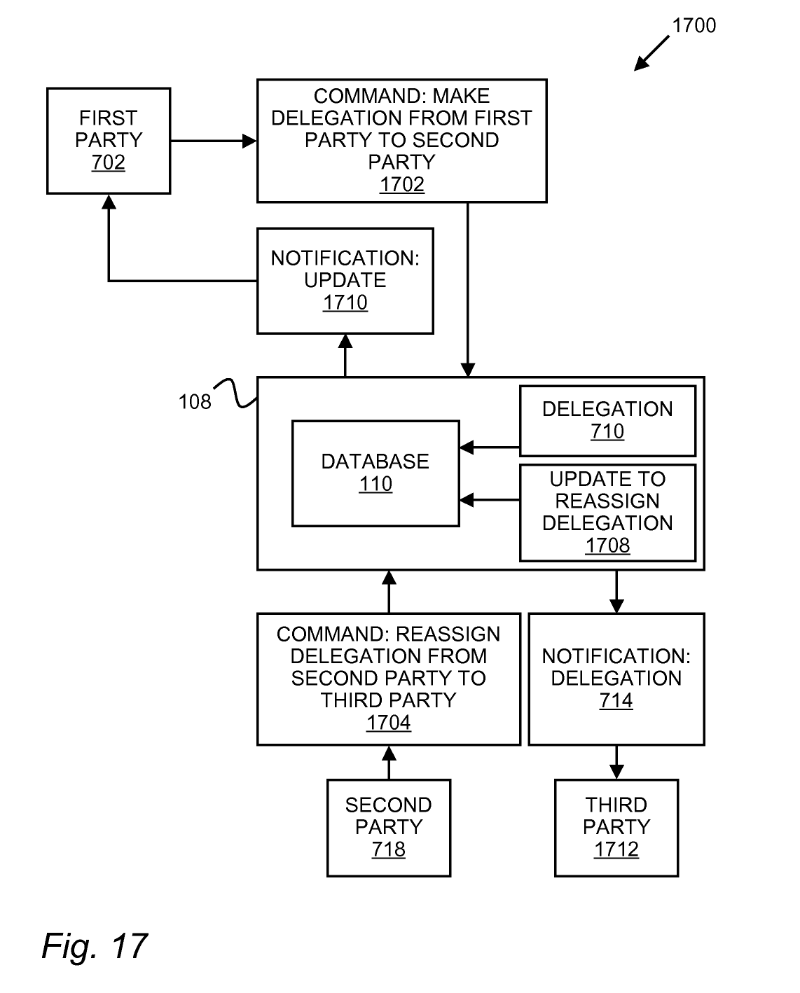

Referring to FIG. 17, the task management system 108 enables the first party 702 to delegate a task to the second party 718, who then reassigns the delegation to a third party 1712. For example, Alice could delegate a task to Bob. (The delegation 710 is from Alice (delegating party) to Bob (delegated party).) Bob, realizing the delegation to him is in error, could reassign the delegation to Carla. (The delegation 710 is now from Alice (delegating party) to Carla (delegated party)—Bob is removed from the delegation 710.)

A task management context 1700 includes the database 110, the task management system 108, the first party 702, the delegation 710, the delegation notification 714, and the second party 718. The task management context 1700 also includes a make-delegation-from-first-party-to-second-party command 1702, a reassign-delegation-from-second-party-to-third-party command 1704, a reassign-delegation update 1708, an update notification 1710, a delegation notification 714, and a third party 1712.

The make-delegation-from-first-party-to-second-party command 1702 is a command 120 from the first party 702 that instructs the task management system 108 to make the delegation 710 of a task 708 from the first party 702 to the second party 718.

The reassign-delegation-from-second-party-to-third-party command 1704 is a command 120 from the second party 718 that instructs the task management system 108 to update the delegation 710 of the task 708 so that it is no longer from the first party 702 to the second party 718, but from the first party 702 to the third party 1712.

The reassign-delegation update 1708 modifies the delegated party indicator 904 of the delegation 710 to indicate the third party 1712 instead of the second party 718, and is written to the database 110 in response to the reassign-delegation-from-second-party-to-third-party command 1704.

The update notification 1710 is a digital message from the task management system 108 to the first party 702 informing the first party 702 that the second party 718 has reassigned the delegation from himself/herself/itself to the third party 1614.

The third party 1712 interacts with the task management system 108 via an instances of the user terminal 118. The third party 1712 can include an individual, a group of individuals, an organization, an automatic system or robot, or the like. The third party 1712 receives the delegation notification 714 from the task management system 108.

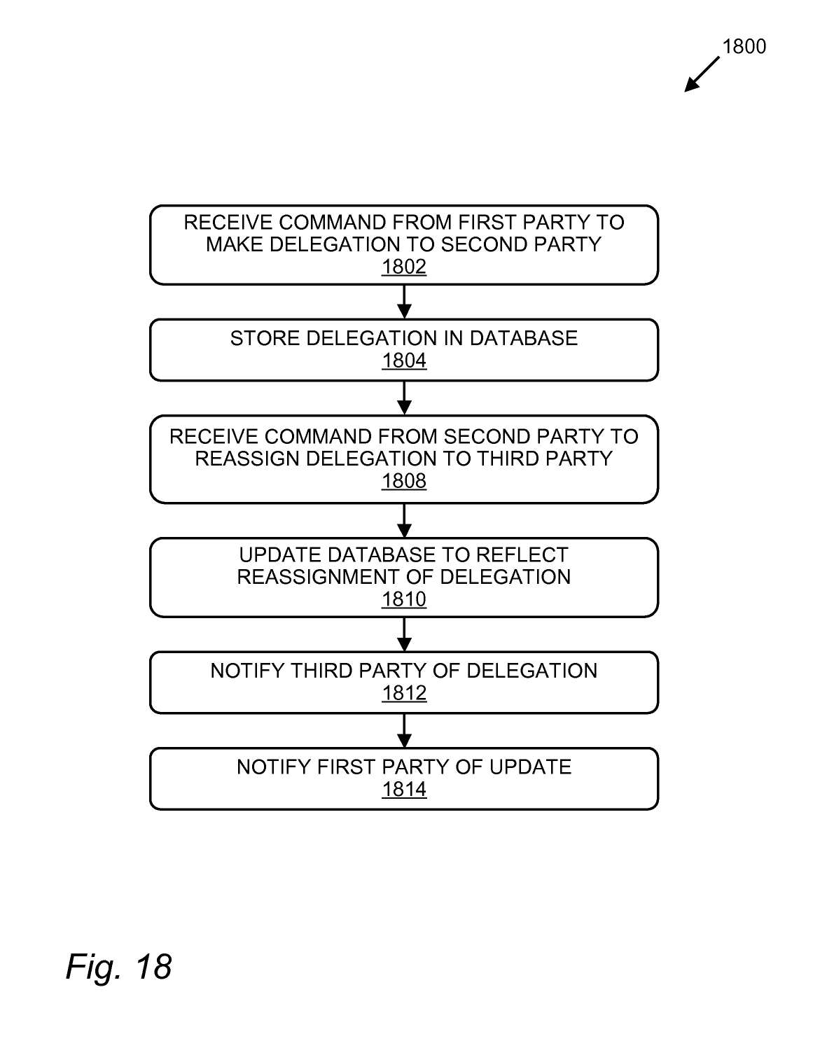

Referring to flowchart 1800 of FIG. 18, the make-delegation-from-first-party-to-second-party command 1702 is received (step 1802). The delegation 710 is written to the database 110 (step 1804). The reassign-delegation-from-second-party-to-third-party command 1704 is received (step 1808). The reassign-delegation update 1708 is written to the database 110 (step 1810). The delegation notification 714 is transmitted to the third party 1712 (step 1812). The update notification 1710 is transmitted to the first party 702 (step 1814).

Referring to FIG. 19, the task management system 108 enables creation and management of trees of delegations. For example, a tree of delegation of length 4 could be formed when Alice delegates a task to Bob, who delegates the task to Carla, who delegates the task to Dave (Alice+Bob+Carla+Dave=4). For illustrative purposes, the trees of delegations described below are of length 3. It will be appreciated that implementations can support trees of delegations of any length.

A task management context 1900 includes the database 110, the task management system 108, the first party 702, the second party 718, and the third party 1712. The task management context 1900 also includes a make-first-delegation-from-first-party-to-second-party command 1902, a first delegation 1904, a make-second-delegation-from-second-party-to-third-party command 1908, a second delegation 1910, and a second-delegation notification 1912.

The make-first-delegation-from-first-party-to-second-party command 1902 is a command 120 from the first party 702 instructing the task management system 108 to delegate a task 708 from the first party 702 to the second party 718.

The first delegation 1904 is a delegation 710 of a task 708 from the first party 702 to the second party 718. The first delegation 1904 is written to the database 110 in response to the make-first-delegation-from-first-party-to-second-party command 1902.

The make-second-delegation-from-second-party-to-third-party command 1908 is a command 120 from the second party 718 instructing the task management system 108 to delegate the task 708 from the second party 718 to the third party 1712.

The second delegation 1910 is a delegation 710 of the task 708 from the second party 718 to the third party 1712. The second delegation 1910 is written to the database 110 in response to the make-second-delegation-from-second-party-to-third-party command 1908.

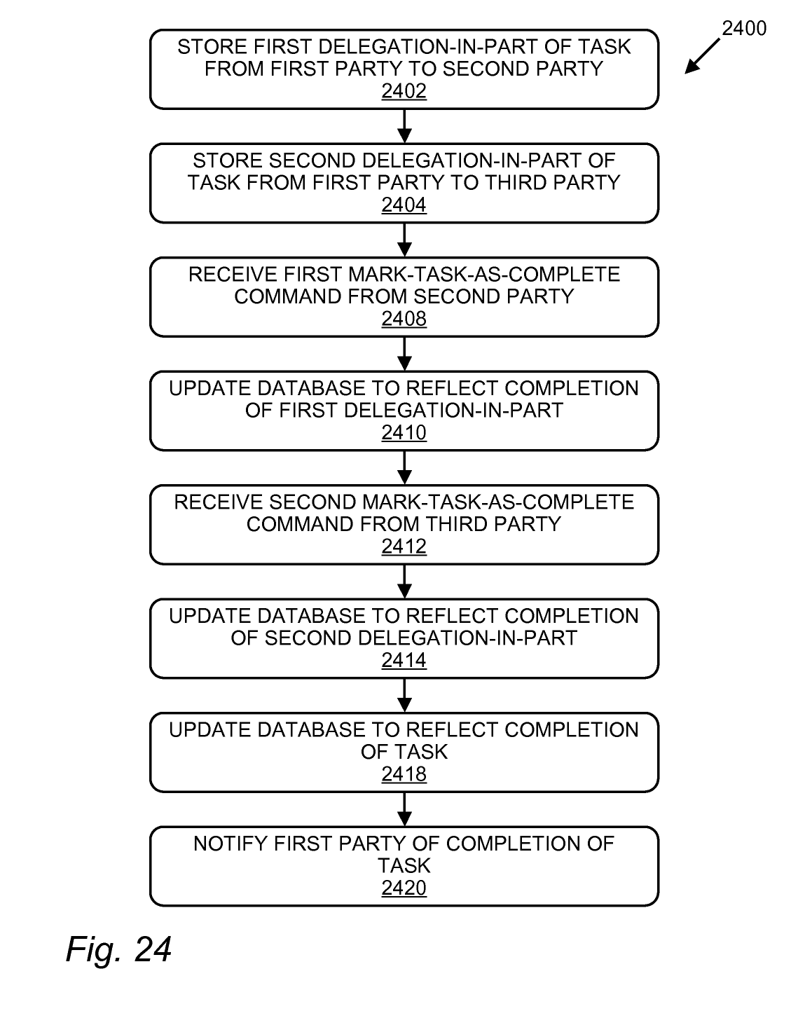

Together, the first delegation 1904 and the second delegation 1910 form a tree of delegations from the first party 702 to the second party 718 to the third party 1712. This tree can be a part of a larger tree of delegations, for example one that includes further delegations from the third party 1712 to other parties, from those parties to still other parties, and so on. It follows that completion of the task 708 can occur by walking back up the tree of delegation. For example, the flowchart 1000 of FIG. 10 depicts steps for completing a task via delegation between two parties (e.g., steps 1014-1022) and FIG. 24 depicts steps for completing a task via delegations-in-part between three parties (e.g., steps 2408-2420). Steps like these can be applied separately or in combination to successive pairs of parties along a tree of delegation of any length, starting from leaves of the tree of delegations and working back up the tree.

The second-delegation notification 1912 is a delegation notification 714 of the second delegation 1910. As depicted, the task management system 108 transmits the second-delegation notification 1912 to the first party 702 and the third party 1712. In this way, the task management system 108 (a) notifies the first party 702 that the second party 718 has delegated the task 708 to the third party 1712 and (b) notifies the third party 1712 that it has been delegated the task 708 by the second party 718.

Since implementations can support trees of delegation of any length, it is possible for the task management system 108 to transmit the second-delegation notification 1912 to any number of parties in the trees. Further to the example above (Alice to Bob, Carla, and Dave), if Dave were to delegate the task to Edgar, the task management system 108 could transmit the second-delegation notification 1912 to any combination of Alice, Bob, and Carla.

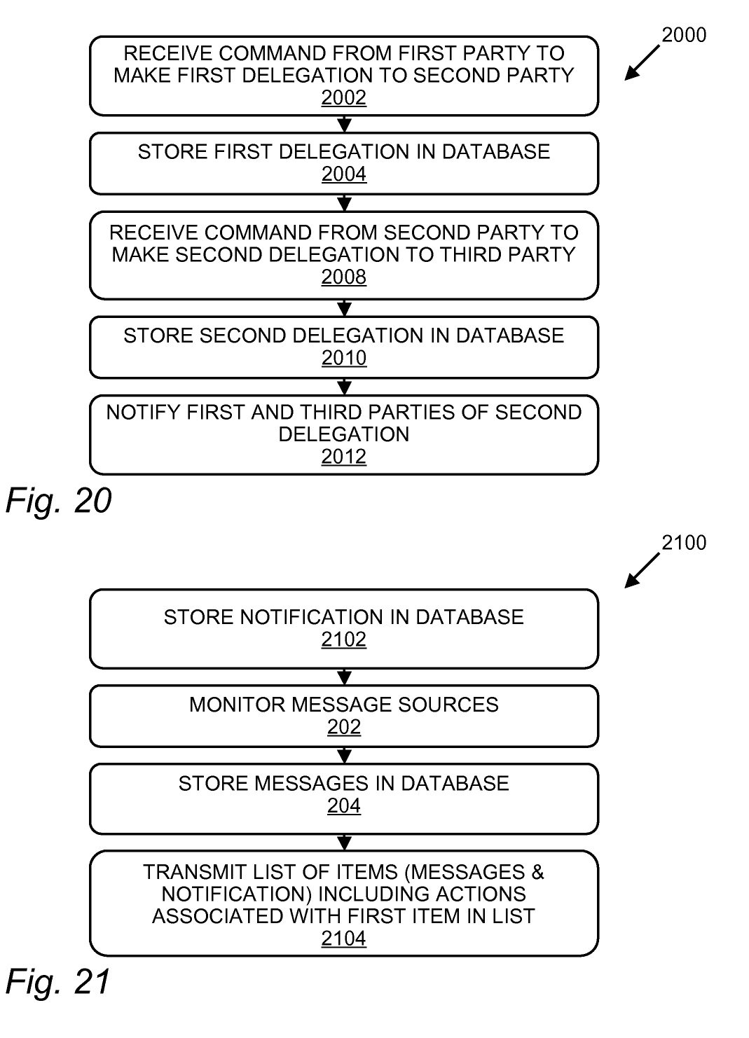

Referring to flowchart 2000 of FIG. 20, the make-first-delegation-from-first-party-to-second-party command 1902 is received (step 2002). The first delegation 1904 is written to the database 110 (step 2004). The make-second-delegation-from-second-party-to-third-party command 1908 is received (step 2008). The second delegation 1910 is written to the database 110 (step 2010). The second-delegation notification 1912 is transmitted to the first party 702 and the third party 1712 (step 2012).

Referring to flowchart 2100 of FIG. 21, transmitting a notification to a party can include transmitting the list 112 to the party, wherein the list 112 includes the notification.

The notification is written to the database 110 (step 2102). Steps 202 and 204 occur as described above with reference to FIG. 2. The list 112 is transmitted (step 2104).

In this context, the list 112 is a list of items including (a) at least some of the plurality of messages (as described above with reference to FIG. 2) and (b) the notification. When the first item is one of the messages, the set of actions may include actions selected from the group of actions 300. When the first item is the notification, the set of actions may include actions selected from a second group of actions 2200.

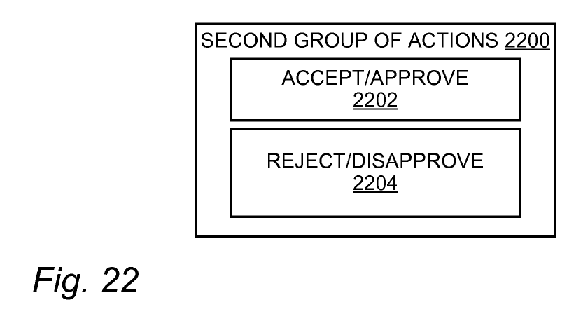

FIG. 22, the second group of actions 2200 includes an approve/accept action 2202 and a disapprove/reject action 2204. The approve/accept action 2202 is an action 114 that upon selection by a party causes the user terminal 118 to transmit at least one command 120 indicating that the party whishes to approve/accept the second delegation 1910. The disapprove/reject action 2204 is an action 114 that upon selection by a party causes the user terminal 118 to transmit at least one command 120 indicating that the party wishes to disapprove/reject the second delegation 1910.

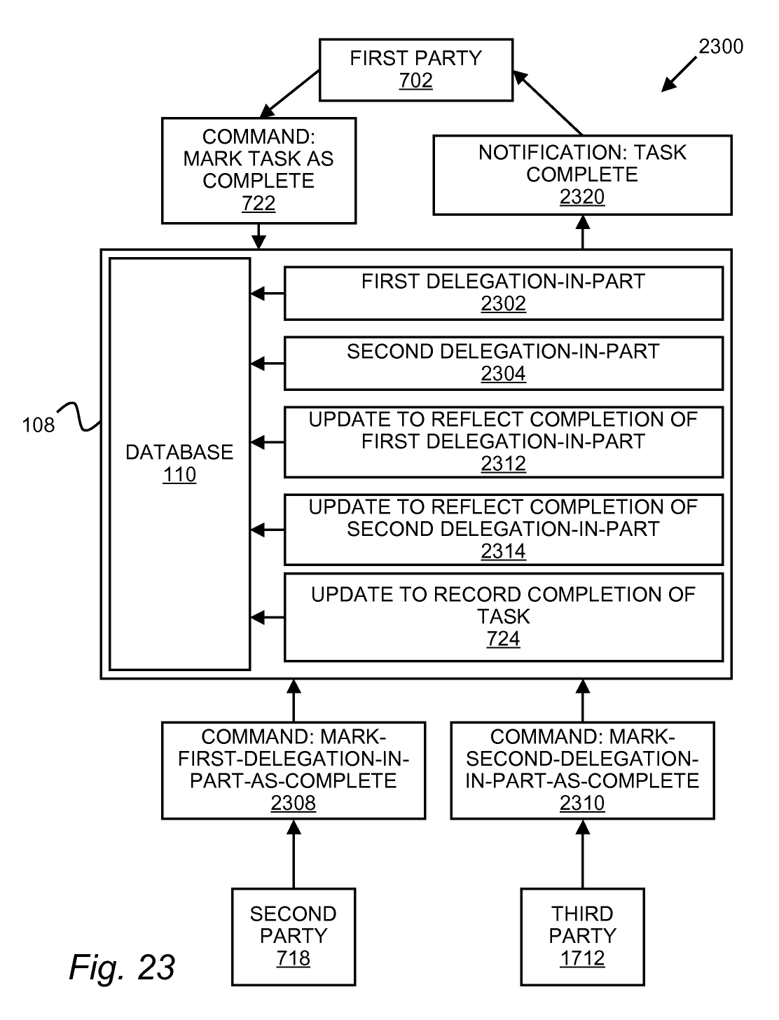

Referring to FIG. 23, the task management system 108 enables a task to be delegated-in-part to a number of parties, each of which is responsible for completing a delegation-in-part of the task 708. The task management system 108 tracks completion of each delegation-in-part and notifies a party when all the delegations-in-part are complete. For example, Alice could delegate a part of a task 708 to Bob and another part of the task 708 to Carla. Bob and Carla, having completed their respective delegations-in-part of the task 708, could independently command the task management system 108 to mark their respective delegations-in-part as complete. The task management system 108 could then notify Alice that all of the delegations-in-part are complete. For illustrative purposes, a task 708 is described below as being broken into two sub-tasks. It will be appreciated that implementations can support tasks being broken into any number of sub-tasks.

A task management context 2300 includes the database 110, the task management system 108, the first party 702, the second party 718, and the third party 1712. The task management context 2300 also includes a first delegation-in-part 2302, a second delegation-in-part 2304, a mark-first-delegation-in-part-as-complete command 2308, a mark-second-delegation-in-part-as-complete command 2310, a completion-of-first-delegation-in-part update 2312, a completion-of-second-delegation-in-part update 2314, a task-complete update 724, and a task-complete notification 2318.

The first delegation-in-part 2302 is a delegation 710 written to the database 110 to reflect delegation-in-part of a task 708 from the first party 702 to the second party 718.

The second delegation-in-part 2304 is a delegation 710 written to the database 110 to reflect delegation-in-part of the task 708 from the first party 702 to the third party 1712.

The mark-first-delegation-in-part-as-complete command 2308 is a command 120 instructing the task management system 108 to mark the first delegation-in-part 2302 as complete.

The mark-second-delegation-in-part-as-complete command 2310 is a command 120 instructing the task management system 108 to mark the second delegation-in-part 2304 as complete.

The completion-of-first-delegation-in-part update 2312 indicates that the first delegation-in-part 2302 is complete, and is written to the database 110 in response to the mark-first-delegation-in-part-as-complete command 2308.

The completion-of-second-delegation-in-part update 2314 indicates that the second delegation in part 2304 is complete, and is written to the database 110 in response to the mark-second-delegation-in-part-as-complete command 2310.

In the context of FIG. 23, the task-complete update 724 is written to the database 110 after (a) receipt of both the mark-first-delegation-in-part-as-complete command 2308 and the mark-second-delegation-in-part-as-complete command 2310 and, perhaps, (b) receipt of the mark-task-as-complete command 722. In this way, the task management system 108 records that the task 708 is complete as a consequence of all delegations-in-part (2302, 2304) of the task 708 being complete.

The task-complete notification 2318 is a digital message from the task management system 108 informing the first party 702 that the task 708 is complete. The task-complete notification 2318 can include details of the delegations-in-part (2302, 2304), details of the task 708, and so on.

Referring to flowchart 2400 of FIG. 24, the first delegation-in-part 2302 is written to the database 110 (step 2402). The second delegation-in-part 2304 is written to the database 110 (step 2404). The mark-first-delegation-in-part-as-complete command 2308 is received (step 2408). The completion-of-first-delegation-in-part update 2312 is written to the database 110 (step 2410). The mark-second-delegation-in-part-as-complete command 2310 is received (step 2412). The completion-of-second-delegation-in-part update 2314 is written to the database (step 2414). The task-complete update 724 is written to the database 110 (step 2418). The task-complete notification 2318 is transmitted to the first party 702 (step 2420).

Referring to FIG. 25, a computer 2502 includes a central processing unit (CPU) 2504, data storage 2508, a network interface 2510, a user input device 2512, and a user output device 2514. Some implementations may omit the user input device 2512 or the user output device 2514. The user terminal 118 is a computer 2502. The task management system 108 can be implemented as the computer 2502 running computer executable code for carrying out the various steps described herein.

Referring to FIG. 26, a peer-to-peer computing system 2600 includes two peer computers (individually, peer computer 2602) in communication via a network 2604. The network 2604 includes any wired or wireless network for carrying Internet data packets or the like. Each of the peer computers 2602 is a computer 2502. Implementations can include any number of peer computers 2602 in communication with one another via the network 2604. The task management system 108 can be implemented as one or more of the peer computers 2602 running computer executable code for carrying out the various steps described herein.

Referring to FIG. 27, a client-server computing system 2700 includes a plurality of client computers (individually, client computer 2702), the network 2604, and a plurality of server computers (individually, server computer 2704). The client computer 2702 is a computer 2502. The server computer 2704 is a computer 2502. The client computer 2702 can communicate with the server computer 2704 via the network 2604. The task management system 108 can be implemented as one or more of the server computers 2704 running computer executable code for carrying out the various steps described herein.

The drawings and specification of this application set forth functional aspects of the disclosed systems. Any and all arrangements of hardware or software for implementing these functional aspects are intended to fall within the scope of this disclosure. Likewise, no particular arrangement of hardware or software for implementing these functional aspects should be inferred from these descriptions unless explicitly stated or otherwise clear from the context.

The foregoing drawings include block diagrams and flowcharts, which depict methods, apparatuses (i.e., systems), and computer program products. Each element of the block diagrams and flowcharts, as well as each respective combination of elements in the block diagrams and flowcharts, illustrates a function of the methods, apparatuses, and computer program products. Any and all such functions (“depicted functions”) can be implemented in computer instructions; in a special-purpose, hardware-based computer system; in a combination of special purpose hardware and computer instructions; in a combination of general purpose hardware and computer instructions; and so on—any and all of which may be referred to herein as a “circuit,” “module,” “system,” or the like.

Each element in flowcharts depicts a step, or group of steps, of a computer-implemented method. Further, each step may contain one or more sub-steps. For the purpose of illustration these steps (as well as any and all other steps identified and described above) are presented in order. In implementations, however, the steps can be carried out in any order suitable for an application at hand. All such variations and modifications are intended to fall within the scope of this disclosure. Thus, the depiction and description of steps in any particular order is not intended to exclude implementations having the steps in a different order, unless required by a particular application, explicitly stated, or otherwise clear from the context.

Computer-executable code can include a finite sequence of computer instructions, including mathematical functions (as in functional programming languages), imperative statements (as in imperative programming languages), and the like. It will be appreciated that a programmable apparatus can receive computer-executable code. By processing the computer instructions of the computer-executable code, a programmable apparatus can produce a further technical effect, store data, transmit signals, and so on.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer-executable code.

A computer is a programmable apparatus including any and all suitable combinations of at least one general purpose computer, special-purpose computer, programmable data processing apparatus, processor, processor architecture, and so on.

A computer can include a non-transitory computer-readable storage medium and that this medium can be internal or external, removable and replaceable, fixed, or the like.

A computer can include a Basic Input/Output System (BIOS), firmware, an operating system, a database, and so forth. These elements can include, interface with, or support the software and hardware described herein.

This disclosure is not limited to applications involving conventional computer programs or programmable apparatuses that run them. For example, an optical computer, quantum computer, analog computer, or the like could be programmed or built to carry out the steps described herein.

Regardless of the type of computer-executable code or computer involved, computer-executable code can be loaded onto a computer to produce a particular machine that can perform any and all of the depicted functions. This particular machine provides a means for carrying out any and all of the depicted functions.

Computer-executable code, data, or the like may be stored in a computer readable medium. In implementations, any combination of one or more computer readable media may be utilized. The computer readable medium may include a computer readable signal medium or a computer readable storage medium. The computer-readable medium may be non-transitory. A computer readable storage medium may include an electronic, magnetic, optical, electromagnetic, infrared, or semiconductor system, apparatus, or device, or any suitable combination of the foregoing. More specific examples (a non-exhaustive list) of the computer readable storage medium includes the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. A computer readable storage medium may include any tangible medium that can contain or store computer-executable code for use by or in connection with a system, apparatus, or device for executing computer-executable code.

A computer readable signal medium may include a propagated data signal with computer-executable code implemented therein, for example, in baseband or as part of a carrier wave. Such a propagated signal may take any of a variety of forms, including, but not limited to, electro-magnetic, optical, or any suitable combination thereof. A computer readable signal medium is a transitory computer readable medium that can communicate, propagate, or transport computer-executable code for use by or in connection with a system, apparatus, or device for executing computer-executable code.

Computer-executable code can be expressed in a variety of languages and application frameworks, including without limitation C, C++, JAVA, JAVASCRIPT, assembly language, Lisp, RUBY ON RAILS, and so on. Such languages may include assembly languages, machine languages, microcode, hardware description languages, database programming languages, functional programming languages, imperative programming languages, and so on. In some implementations, computer-executable code can be stored, compiled, or interpreted to run on a computer, a programmable data processing apparatus, a heterogeneous combination of processors or processor architectures, and so on. Without limitation, implementations of the present invention can take the form of web-based computer software, which includes client/server software, software-as-a-service, peer-to-peer software, or the like.

In some implementations, computer-executable code is multi-threaded code or multi-process code. The multiple programs or threads instantiated by executing the computer-executable code may be processed more or less simultaneously. By way of implementation, any and all methods, program codes, program instructions, and the like described herein may be implemented in one or more thread, in one or more process, and so on. Threads and processes may be prioritized and may be executed simultaneously, in order of priority, or in any other order.

Computer-executable code can be stored in a computer-readable storage medium capable of directing a computer or other programmable data processing apparatus to function in a particular manner. When the computer-readable storage medium is non-transitory, the medium together with the code stored therein constitute an article of manufacture that can be for implementing any and all of the depicted functions.

Computer-executable code implemented in computer readable medium may be transmitted via a wire, optical fiber cable, radiofrequency transmission, any suitable combination of the foregoing, and the like.

The flowcharts and block diagrams imply logical boundaries between the elements therein. However, according to software or hardware engineering practices, the depicted elements and the functions thereof may be implemented as parts of a monolithic software structure; as standalone software modules; as modules that employ external routines, code, services, and so on; and so forth. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, computer-program products comprising computer-executable code stored in a non-transitory computer readable medium for performing the specified functions, and so on.

A computing system includes any suitable combination of computers and computer-executable code stored in computer readable media. A variety of computing systems are described in this application and others will be appreciated.

Unless otherwise stated or clear from the context, verbs like “execute” and “process,” when used in a context implying execution of computer-executable code, include any and all combinations of executing, processing, interpreting, compiling, assembling, linking, loading, etc. of computer-executable code. Therefore, implementations that execute computer-executable code or the like can suitably act upon the computer-executable code in any and all of the ways just described.

Method steps are intended to include any suitable method of causing one or more parties or entities to perform the steps consistent with patentability of the following claims, unless a different meaning is expressed or otherwise clear from the context. Such parties or entities need not be under the direction or control of any other party or entity, and need not be located within a particular jurisdiction. For example, a description or recitation of “adding a first number to a second number” includes causing one or more parties or entities to add the two numbers together. It follows that if person X engages in an arm's length transaction with person Y to add the two numbers, and person Y indeed adds the two numbers, then both persons X and Y perform the step as recited: person Y by virtue of the fact that he actually added the numbers and person X by virtue of the fact that he caused person Y to add the numbers. It furthermore follows that if person X is located within the United States and person Y is located outside of the United States then the method is performed in the United States by virtue of person X's participation in causing the step to be performed.

References to items in the singular should be understood to include items in the plural, and vice versa, unless explicitly stated otherwise or clear from the text; grammatical conjunctions are intended to express any and all disjunctive and conjunctive combinations of conjoined clauses, sentences, words, and the like, unless otherwise stated or clear from the context.

Other implementations are within the scope of the following claims.

What is claimed is:

1. A method, comprising:
monitoring a plurality of information sources for messages;
storing the messages in a database; and
transmitting a list of the messages, the list having a first message and including a set of actions associated with the first message, the set of actions including a create-task action and a create-and-delegate-task action.

2. The method of claim 1, wherein the set of actions further includes a create-task-and-mark-it-as-complete action.

3. A system, comprising:
a computing system configured to monitor a plurality of information sources for messages and to transmit a list of the messages, the list having a first message and including a set of actions associated with the first message, the set of actions including a create-task action and a created-and-delegate-task action.

4. The system of claim 3, wherein the set of actions further includes a create-task-and-mark-it-as-complete action.

5. A computer program product embodied in a non-transitory computer readable medium, the computer program product comprising computer code that, when run on a computing system, performs the steps of:
monitoring a plurality of information sources for messages;
storing the messages in a database; and
transmitting a list of the messages, the list having a first message and including a set of actions associated with the first message, the set of actions including a create-task action and a create-and-delegate-task action.

6. The computer program product of claim 5, wherein the set of actions further includes a create-task-and-mark-it-as-complete action.
